(19) United States
(12) Patent Application Publication
(10) Pub. No.: US 2012/0222361 A1
(43) Pub. Date: Sep. 6, 2012

(54) Draft Stopping Device

(76) Inventors: Andrea Farucci, White Plains, NY (US); Anna Chiaravalle, White Plains, NY (US)

(21) Appl. No.: 13/401,961

(22) Filed: Feb. 22, 2012

Related U.S. Application Data
(60) Provisional application No. 61/448,401, filed on Mar. 2, 2011.

(51) Int. Cl. E06B 7/16

(52) U.S. Cl. 49/475.1

(57) ABSTRACT

A draft stopping device comprised of interior and exterior insulation that allows a user to effectively and efficiently prevent or reduce drafts from entering a home or other structure beneath an exterior door or window. The draft stopping device is relatively inexpensive to manufacture, aesthetically pleasing, and does not require installation hardware that can damage the surface of the exterior door or window for which it is being used.

### CROSS-REFERENCE

This application claims priority from Provisional Patent Application Ser. No. 61/448,401 filed Mar. 2, 2011.

### FIELD OF THE INVENTION

This invention relates to a device for blocking drafts from exterior doors, windows and the like, wherein said device exhibits improved insulating capabilities and does not require installation hardware.

### BACKGROUND

With today's rising energy costs, many homeowners and individuals responsible for heating and cooling buildings and other structures are continuously looking for ways to reduce energy costs associated with heating and/or cooling the structure. One well known way of conserving energy and reducing heating and cooling costs is through weatherproofing. One particular method of weatherproofing is preventing drafts of hot or cold air to enter or leave the home or structure beneath exterior doors and/or windows. More specifically, during colder months it is desirable to prevent cold air from entering a home or other structure in the form of a draft from beneath an exterior door or window. Similarly, during warmer months, for example when the homeowner may have the air conditioning turned on, it is oftentimes desirable to prevent the air conditioned air within the home or other structure from escaping through the openings beneath an exterior door and/or window.

Draft stopping or excluding devices are generally known in the art, and are somewhat useful for preventing or reducing drafts from entering a home, building or other structures from beneath exterior doors, windows and the like, and for preventing heated or air conditioned air from escaping. Many of these prior art draft stopping devices are comprised of a flexible elongated member filled with wood shavings, sand or some other form of insulation, but said devices do not include any form of insulation on the exterior of the device. Moreover, because these prior art devices are flexible, they tend to bunch up and not lie flat on the floor thereby allowing drafts to enter the structure, particularly because the devices do not have any form of insulation on their exterior surface.

Other prior art draft stopping devices must be attached to the door or window with hardware such as screws, fasteners and the like. However, the need for such installation hardware tends to increase the manufacturing cost and, therefore, the price of the device, and can be time-consuming to install. Further, the installation hardware can cause damage to the door or window to which the draft stopping device is attached that could be costly to repair or replace when the device is removed from the same.

Yet other prior art draft stopping devices, such as the one disclosed in U.S. Pat. No. 4,765,094, have an attachment means that extends beneath the bottom surface of the exterior door or window and allegedly holds the device in position as the door is being opened or closed. While this type of draft stopping device does not require the use of installation hardware, the opening and closing of the door to which this type of device is attached tends to cause the device to shift out of position and fail of its essential purpose (i.e., preventing drafts from entering the structure). Moreover, over time, the continuous opening and closing of the door tends to cause damage to the attachment means, as well as the draft stopping device, thereby also diminishing its usefulness.

Consequently, there exists in the art a long-felt need for an improved draft stopping device that overcomes the limitations associated with the prior art. More specifically, there is a long felt need in the art for a draft stopping device that can be comprised of both interior and exterior insulation and that does not require the use of installation hardware. Finally, there is a long-felt need for a draft stopping device that is relative easy and inexpensive to manufacture and use, and that can be used with a multitude of different types of exterior doors and/or windows.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an improved draft stopping device comprised of an elongated member and an exterior insulating material removably attached thereto, wherein said elongated member further comprises a core containing interior insulating material and does not require installation hardware to be utilized in conjunction with an exterior door or window. In an alternative embodiment, said elongated member may be a solid, and not have an interior core.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of the top and side portions of one embodiment of the draft stopping device of the present invention with an exterior insulating material comprised of carpet fibers.

FIG. 2 is a cross-sectional view of the draft stopping device depicted in FIG. 1, illustrating the core and interior insulating materials.

FIG. 2A is a cross-sectional view of the draft stopping device depicted in FIG. 1, but with a solid elongated member (i.e., no core).

FIG. 3 is a perspective view of the bottom and side portions of one embodiment of the draft stopping device depicted in FIG. 1.

FIG. 4 is a perspective view of the draft stopping device of FIG. 1 positioned away from the interior side of a door, thereby permitting a draft (depicted by arrows) to enter the structure from beneath the door.

FIG. 5 is a perspective view of the draft stopping of FIG. 4 properly positioned adjacent to, and in contact with, the interior side of the door.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

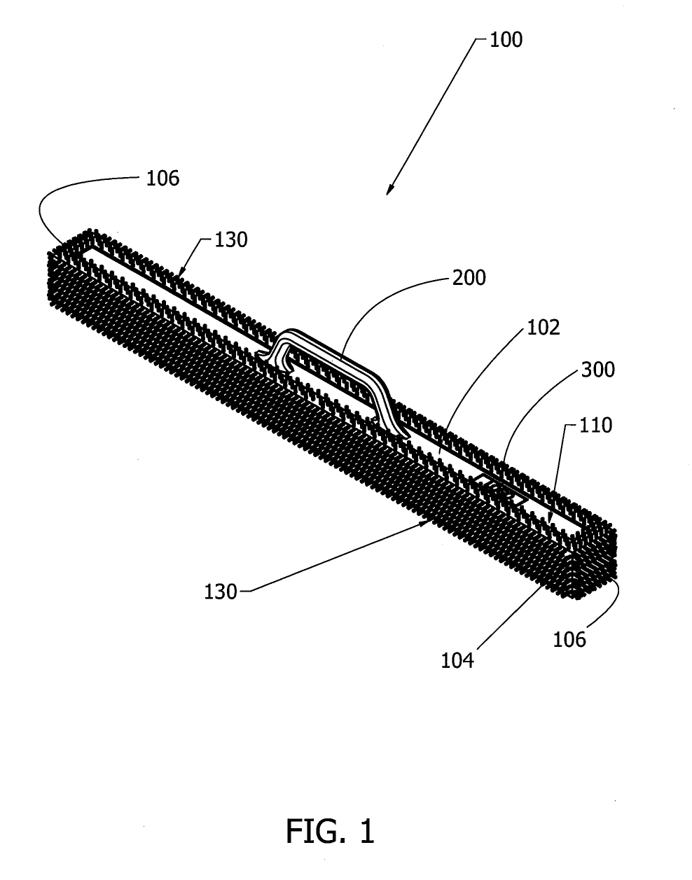

Referring initially to the drawings, FIG. 1 illustrates a perspective view of but one embodiment of the draft stopping device 100 of the present invention. Draft stopping device 100 is preferably comprised of an elongated member 110 with a generally square or rectangular shaped cross-section, though it is contemplated that other shapes could also be used, and is substantially wrapped or encompassed in an exterior insulating material 130, each of which is described in greater detail below. Draft stopping device 100 further comprises a top portion 102, side portions 104, end portions 106 and bottom portion 108.

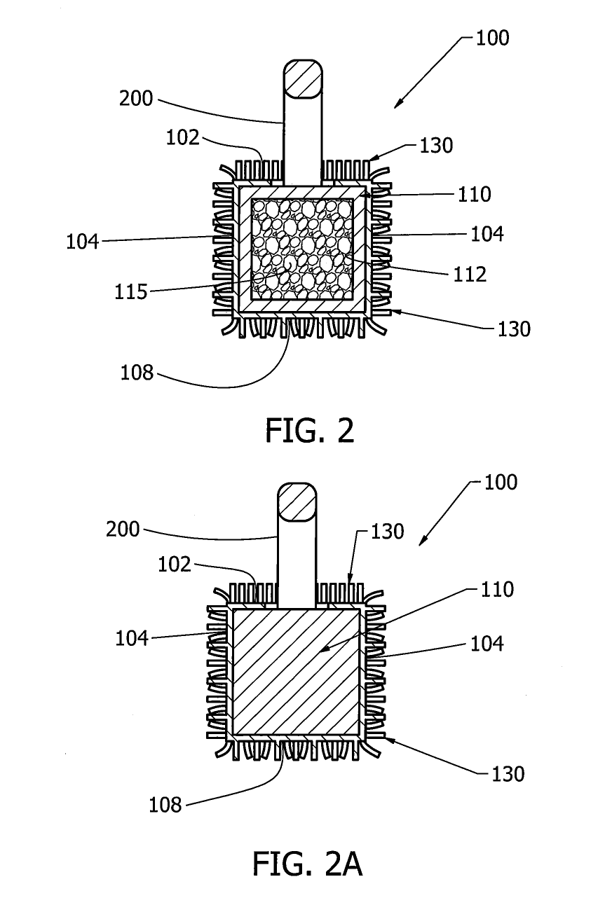

Elongated member 110 is preferably formed of a substantially rigid material such as plastic, though it is contemplated that other materials such as wood, metal, and the like could also be used affecting the overall concept of the present invention. Elongated member 110 preferably has a hollow core 112, which can be filled with interior insulating material 115, such as sand, fiberglass, foam, commercially available insulation, or the like. FIG. 2 illustrates a cross section of draft stopper device 100 and illustrates but one embodiment of core 112 and interior insulating material 115. Alternatively, it is also contemplated that elongated member 110 could be a solid (i.e., without hollow core 112), as is illustrated in FIG. 2A.

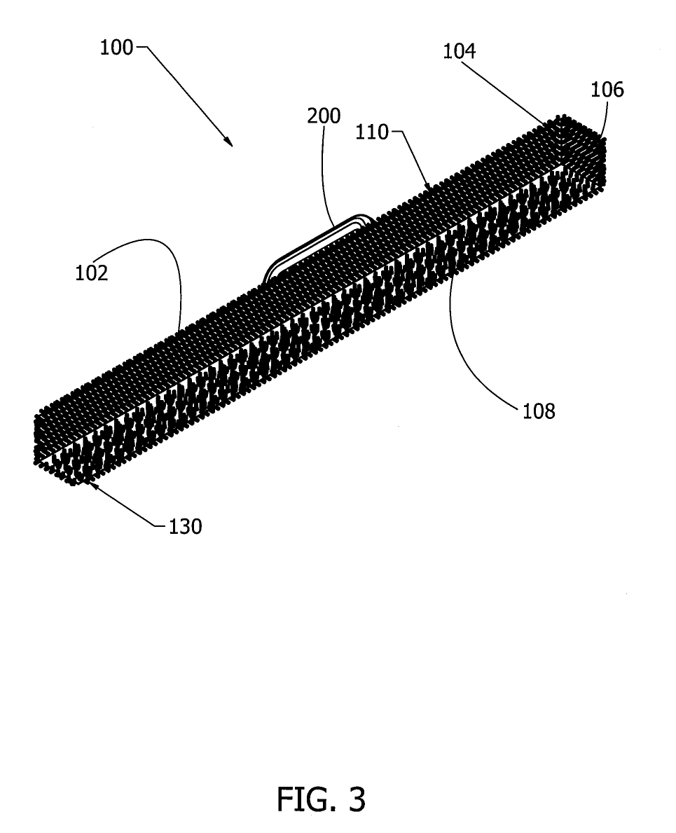

As an important aspect of the present invention, exterior insulating material 130 is preferably comprised of carpet fibers, though it is contemplated that exterior insulating material 130 could also be comprised of other insulating materials such as sponge, cloth, velvet, weather seal or the like without affecting the overall concept of the present invention. In a preferred embodiment of the present invention, exterior insulating material 130 covers a substantial portion (i.e., more than 50% of the overall surface area) of elongated member 110. For example, exterior insulating material 130 may cover side portions 104, end portions 106, bottom portion 108 and substantial amount of top portion 102, as illustrated in FIGS. 1-3. Nonetheless, it is contemplated that other embodiments could also be employed. For example, exterior insulating material 130 could be applied only to the side portion 104 of draft stopping device 100 that is placed in contact with an interior portion 410 of an exterior door or window 400. In yet another embodiment, exterior insulating material 130 could be applied to the top surface 102, bottom surface 108, and the side portion 104 of draft stopping device 100 that is placed in contact with an interior portion 410 of an exterior door or window 400.

Exterior insulating material 130 may be in the form of an expandable sleeve or sock that can be removably attached to elongated member 110 by slipping exterior insulating material 130 over elongated member 110. When exterior insulating material 130 is removably attached to elongated member 110, it can easily be removed for periodic cleaning. Alternatively, and particularly if exterior insulating material 130 is used only to cover portions of draft stopping device 100, exterior insulating material 130 may be fixedly attached to the desired portions of elongated member 110 by any common means known in the art such as glue, staples, brad nails or other types of fasteners including, without limitation, hook and loop fasteners.

Draft stopping device 100 can be sized and manufactured to accommodate user preference, though it is contemplated that draft stopper device should be between 30 and 40 inches in length as measured from one end portion 106 to opposite end portion 106, between one and five inches in width as measured from one side portion 104 to opposite side portion 104, and between one and five inches in depth as measured from top portion 102 to bottom portion 108. Notwithstanding, the length of draft stopping device 100 should be at least equal to the width of the door or window 400 for which it is being used.

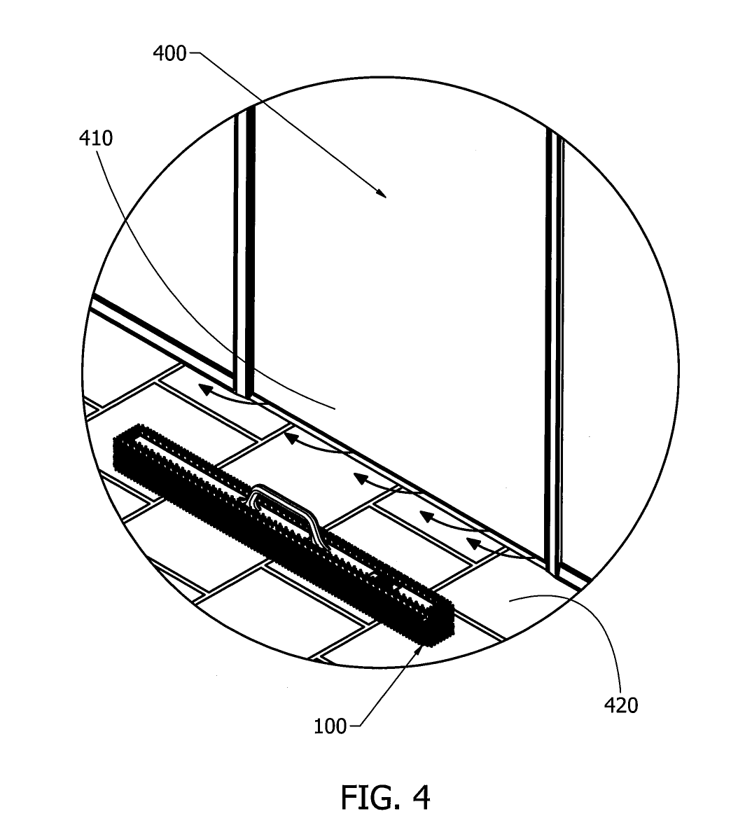

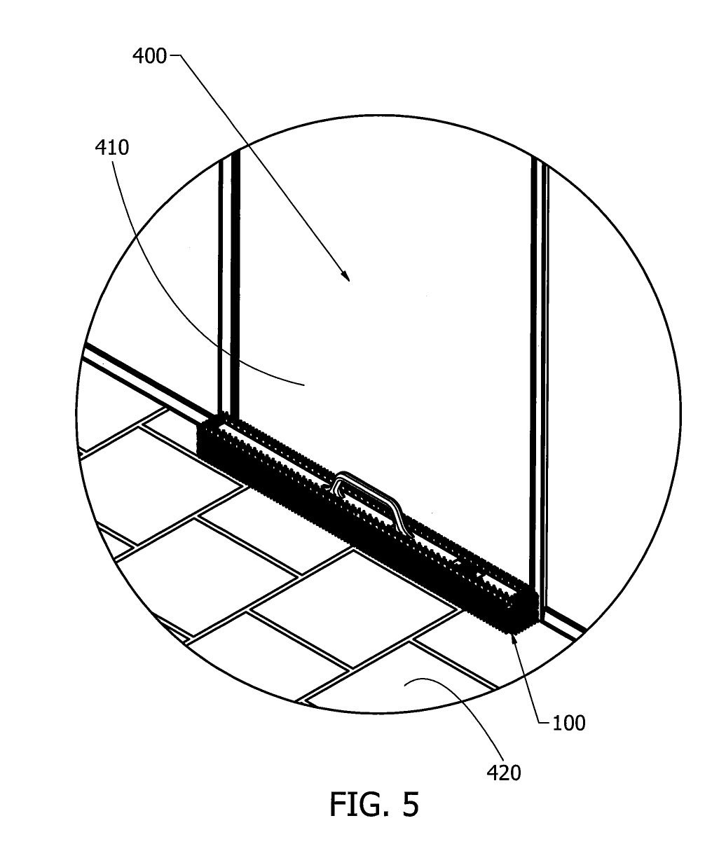

Having now described the preferred embodiment of draft stopping device 100, its use and usefulness will now be described. FIG. 4 shows a preferred embodiment of the draft stopping device 100 of the present invention placed on a floor 420 in spaced apart relationship from the interior portion 410 of exterior door 400. To install draft stopping device 100, a user (not shown) simply positions device 100 on the floor 420 and against the interior portion 410 of exterior door 400, as best illustrated in FIG. 5, thereby blocking the flow of air from beneath door 400. More specifically, elongated member 110, and the insulating material 115 contained therein, working in conjunction with exterior insulating material 130 prevents or substantially reduces the amount of draft that is otherwise permitted to pass beneath door 400, as illustrated by arrows in FIG. 4. In an alternative embodiment in which elongated member 110 is a solid (i.e., without an insulation filled core), elongated member 110 works in conjunction with exterior insulating material 130 to prevent or substantially reduce the amount of draft that is otherwise permitted to pass beneath door 400.

Moreover, because elongated member 110 is substantially rigid it will not substantially deform or bunch up like the flexible draft stopper devices of the prior art when jostled or repositioned, which could result in the flow of unwanted air into and out of the home or structure. More specifically, the rigidity of elongated member 110 helps to ensure that the bottom portion 108 of draft stopping device 100 remains in relatively constant contact with the floor 420, as best illustrated in FIGS. 4 and 5. Similarly, the rigidity of elongated member 110 also helps to ensure that at least one side portion 104 of draft stopping device 100 remains in relatively constant contact with the interior portion 410 of door 400, when properly installed. Notwithstanding, draft stopping device 100 is light enough that it will not unduly interfere with the opening and closing of door or window 400. For example, as door 400 is opened inward (i.e., in the direction of draft stopping device 100), device 100 will be pushed along floor 420 by the interior portion 410 of door 400. Once door 400 is closed, user (not shown) can simply reinstall device 100 as described supra.

As illustrated in the various FIGS., draft stopping device 100 may further comprise a handle 200, which may be mounted to the top surface 102 of draft stopping device 100 for easy handling and positioning of device 100. Alternatively, it is contemplated that optional handle 200 could also be attached to any of the side portions 104 or end portions 106 of draft stopping device 100 without affecting the overall concept of the present invention. In either instance, handle 200 may be attached to device 100 by any means commonly known in the art such as with screws, nails, glue, fasteners or the like, or it may be a plastic handle 200 molded as a single unit with a plastic elongated member 110. It is also contemplated that a logo or other message 300 could be printed on, or attached to, draft stopping device 100, as best illustrated in FIG. 1.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A draft stopping device comprising:
an elongated member further comprised of a core;
an interior insulating material stored in said core; and
an exterior insulating material.

2. The draft stopping device of claim 1 wherein said interior insulating material is comprised of at least one of: sand, fiberglass, foam or insulation.

3. The draft stopping device of claim 1 wherein said exterior insulating material is comprised of at least one of: carpet fibers, cloth, velvet, sponge or weather seal.

4. The draft stopping device of claim 1 wherein said exterior insulating material is removably attached to the elongated member.

5. The draft stopping device of claim 1 further comprising a handle.

6. The draft stopping device of claim 1 wherein said elongated member is comprised of plastic.

7. The draft stopping device of claim 1 wherein said elongated member is comprised of wood.

8. A draft stopping device comprising:
an elongated member having a surface area and being further comprised of a core;
an interior insulating material stored in said core; and
an exterior insulating material, wherein said exterior insulating material covers more than 50 percent of the total surface area of said elongated member.

9. The draft stopping device of claim 8 wherein said interior insulating material is comprised of at least one of: sand, fiberglass, foam or insulation.

10. The draft stopping device of claim 8 wherein said exterior insulating material is comprised of at least one of: carpet fibers, cloth, velvet, sponge or weather seal.

11. The draft stopping device of claim 8 further comprising a handle.

12. The draft stopping device of claim 8 wherein said elongated member is comprised of plastic.

13. The draft stopping device of claim 8 wherein said elongated member is comprised of metal.

14. A draft stopping device comprising:
an elongated member having a surface area; and
an exterior insulating material, wherein said exterior insulating material encompasses a substantial portion of the total surface area of said elongated member and is removably attached to said elongated member.

15. The draft stopping device of claim 14 wherein said substantial portion of the total surface area of said elongated member is more than 50 percent.

16. The draft stopping device of claim 14 wherein said exterior insulating material is comprised of at least one of: carpet fibers, cloth, velvet, sponge or weather seal.

17. The draft stopping device of claim 14 further comprising a handle.

18. The draft stopping device of claim 14 wherein said elongated member is comprised of plastic.

19. The draft stopping device of claim 14 wherein said elongated member is comprised of metal.

20. The draft stopping device of claim 14 wherein said elongated member is comprised of wood.
